(19) United States
(12) Patent Application Publication
(10) Pub. No.: US 2017/0072320 A1
(43) Pub. Date: Mar. 16, 2017

(54) Discovering and Executing a Synergy in a Video Game

(71) Applicant: Xaviant, LLC (a GA Limited Liability Company), Cumming, GA (US)

(72) Inventor: Michael Parker McMain, Dawsonville, GA (US)

(73) Assignee: Xaviant, LLC (a GA Limited Liability Company), Cumming, GA (US)

(21) Appl. No.: 15/260,490

(22) Filed: Sep. 9, 2016

Related U.S. Application Data
(60) Provisional application No. 62/218,315, filed on Sep. 14, 2015.

(51) Int. Cl. A63F 13/822; A63F 13/20; A63F 13/335; A63F 13/60

(52) U.S. Cl. CPC A63F 13/822; A63F 13/60; A63F 13/20; A63F 13/335; A63F 2300/807

(57) ABSTRACT

In a computer-based game, discovery and execution a synergy is facilitated. A synergy notification is randomly generated in response to a player event. The synergy notification indicates a discovery of a synergy and optionally includes a synergy quest to be completed by a player. When the player completes the synergy quest, the synergy is unlocked. Accordingly, the synergy is executed if two consecutive synergy actions are detected within a predetermined time window.

### CROSS-REFERENCE TO RELATED APPLICATION

This application claims the benefit of U.S. provisional application No. 62/218,315 filed on Sep. 14, 2015, the disclosure of which is incorporated by reference.

### BACKGROUND

A role-playing video game (RPG) is a video game genre where a player controls the actions of one or more characters immersed in a virtual world. An RPG typically involves developed storytelling, narrative elements, replayability, and character development. In a typical RPG, a character may navigate through different locations in the virtual world while fighting battles, acquiring goods, and solving tasks along the way. As a reward for successfully winning battles, acquiring goods, or solving tasks, the RPG may increase the abilities and attributes of the character. That is, the RPG may include a character-growth system that allows the character to become stronger as the game progresses.

For example, the RPG may incorporate level-based system whereby the character may receive experience points by winning battles, acquiring goods, and solving tasks. Once a certain amount of experience is gained, the character advances a level. In some RPGs, a level-up occurs automatically when the required amount of experience is reached, and in others, the player can choose when and where to advance a level. Likewise, abilities and attributes may increase automatically or manually based on the accumulated experience points. Alternatively, the character may develop their abilities and attributes by training. For instance, if the character wields a sword for an amount of time, the character's sword abilities may progress with time.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of a machine to facilitate the discovery and execution of a synergy in a video game, according to an example of the present disclosure;

FIG. 2 shows a flow diagram of the method to facilitate the discovery and execution of a synergy in a video game, according to an example of the present disclosure;

FIG. 3 shows a perspective view of a synergy notification during gameplay, according to an example of the present disclosure;

FIG. 4 shows a synergy quest menu, according to an example of the present disclosure;

FIG. 5 shows a perspective view of a critical hit on an enemy during gameplay, according to an example of the present disclosure;

FIG. 6 shows a perspective view of a apocalyptical hit on an enemy during gameplay, according to an example of the present disclosure; and

FIG. 7 shows a perspective view of synergy during gameplay, according to an example of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

As used herein, the terms “a” and “an” are intended to denote at least one of a particular element, the term “includes” means includes but not limited to, the term “including” means including but not limited to, and the term “based on” means based at least in part on. Throughout this description, even though a real person is the player, reference to “the player” is synonymous to reference to the player's virtual character within the virtual game space.

Disclosed herein are examples of a method to facilitate the discovery and execution of a synergy in a video game. A synergy, for example, may result in awarding a player with a high level of power and prowess that far exceeds that of typical spells, weapons, and potions. A synergy may include, but is not limited to, awarding the player with an innate strength ability, magic ability, healing ability, or combat ability. In this regard, the disclosed method may promote an element of discovery to keep a player engaged in the video game while simultaneously challenging the player's skill in executing the discovered synergy. Also disclosed herein is a computing device for implementing the methods and a non-transitory computer readable medium on which is stored machine readable instructions that implement the methods.

According to an example, a method to discover and execute a synergy in a video game includes randomly generating a synergy notification in response to a player event such as the crafting of a spell, the casting of a spell, the creating of a weapon, the wielding of a weapon, the uncovering of an in-game item, and or the use of a player ability. The synergy notification may indicate a discovery of a synergy with unknown powers and may include a synergy quest to be completed by a player to reveal the identity of the unknown powers of the synergy. In response to the player successfully completing the synergy quest, the synergy is unlocked to reveal the identity of its unknown powers. Accordingly, the method may facilitate the execution of the synergy in response to detecting two consecutive synergy actions by the player within a predetermined time window. The two consecutive synergy actions, for instance, include a first apocalyptical hit performed in a first spell followed by a second apocalyptical hit in a second spell.

In standard RPGs, special abilities or innate powers are typically unlocked at intervals by a player through achieving milestones. For example, these milestones take the form of acquiring experience points or developing abilities and attributes by training. Alternatively, the player purchases the special abilities or innate powers from a non-player character who teaches the special abilities or innate powers to the player. The player, however, does not experience a sense of discovery of the special abilities or innate powers, and therefore, does not feel a sense of ownership of the given ability or power. Accordingly, in standard RPGs, the player simply spends points that they earn for a predetermined set of abilities or powers. The end result is that the player quickly sees the combination of all possibilities as they are not promoted by player discovery.

The disclosed examples promote an element of discovery that enhances a player's engagement in the video game. Because the awarding of synergies is completely random, a player is perpetually intrigued to pursue undiscovered synergies. According to the disclosed examples, once a player randomly discovers a synergy with unknown powers, the player embarks upon an adventure of discovery set forth in a synergy quest to unlock the synergy with unknown powers. When the player completes the discovery, they are challenged to execute the unlocked synergy with a combination of complex player actions to unleash the synergy. Therefore, the disclosed examples promote a rewarding and fulfilling experience for the player whereby the player feels that they have earned the synergy through their discovery and execution thereof.

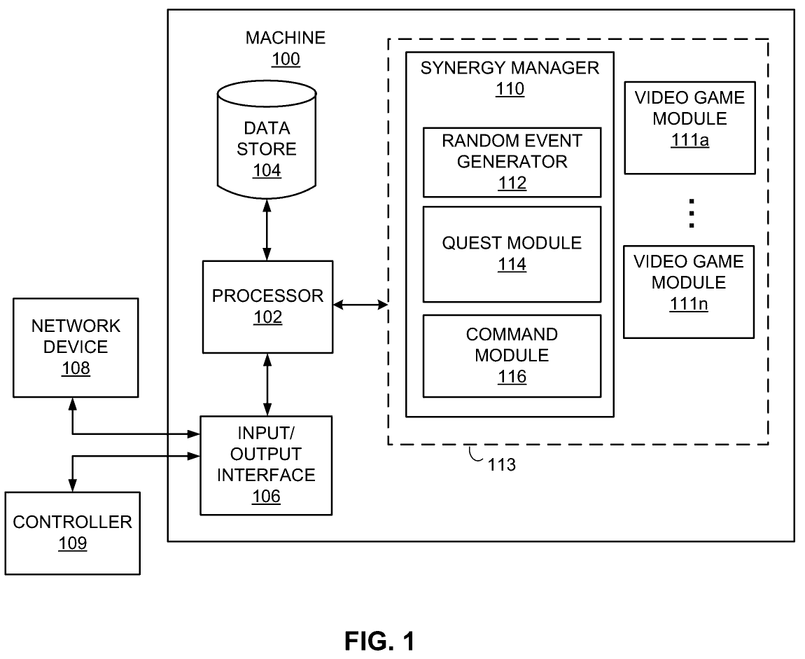

With reference to FIG. 1, there is shown a block diagram of a machine 100 that facilitates the discovery and execution of a synergy in a video game, according to an example of the present disclosure. It should be understood that in some embodiments the machine 100 includes additional components and that one or more of the components described herein may be removed and/or modified without departing from a scope of the machine 100.

The machine 100 is depicted as including a processor 102, a data store 104, an input/output interface 106, a synergy manager 110, and a controller 109. The machine 100, for example, is a computer. For example, a personal computer, game console, server, mobile handset, etc., but other types of computers may be used. Also, the components of the machine 100 are shown on a single computer as an example and in other examples the components exist on multiple computers. The machine 100 may store progress data in a video game for a player in the data store 104 and/or manages the storage of data stored in a separate machine, for instance, through a network device 108, which includes, for instance, a router, a switch, a hub, etc. The data store 104 includes a storage device, such as hard disk, memory, etc.

The synergy manager 110 is depicted as including a random event generator 112, a quest module 114, and a command module 116. The processor 102, which is, for example, a microprocessor, a micro-controller, an application specific integrated circuit (ASIC), or the like, is to perform various processing functions in the machine 100. The processing functions include the functions of the random event generator 112, a quest module 114, and a command module 116 of the synergy manager 110 as discussed in greater detail below.

In one example, the synergy manager 110 comprises machine readable instructions stored on a non-transitory computer readable medium 113 and executed by the processor 102. Examples of the non-transitory computer readable medium include dynamic random access memory (DRAM), electrically erasable programmable read-only memory (EEPROM), magnetoresistive random access memory (MRAM), memristor, flash memory, hard drive, and the like. The computer readable medium 113 is, for example, included in the data store 104 or may be a separate storage device. In another example, the synergy manager 110 comprises a hardware device, such as a circuit or multiple circuits arranged on a board. In this example, the input module 112, the menu engine 114, and the save module 116 comprise circuit components or individual circuits, such as an embedded system or Application-Specific Integrated Circuit (ASIC) or Field-Programmable Gate Arrays (FPGAs).

The input/output interface 106 includes a hardware and/or a software interface. The input/output interface 106 is, for example, a network interface connected to a network, such as the Internet, an intranet, etc., over which the synergy manager 110 receives and communicates information. The processor 102 stores information received through the input/output interface 106 in the data store 104 and uses the information in implementing the input module 112, the menu engine 114, and the save module 116. In some embodiments, the data store 104 includes volatile and/or non-volatile data storage.

According to another example, a player transmits a plurality of commands from the controller 109 to the processor 102 via the input/output interface 106. The controller 109 is, for example, a device that provides user input to the machine 100. The controller 109 is typically used with video games or entertainment systems to provide input to the video game, typically to control an object or character in the video game. The controller 109 is connected to the machine 100 by a wired or wireless interface. The controller 109 is, for example, but is not limited to, a gamepad, a paddle, a joystick, a trackball, a throttle quadrant, a steering wheel, a yoke, a pedal, a keyboard and mouse, a touch screen, a motion sensing device, a light gun, a microphone, a rhythm game controller, and dance pad. The processor 102 implements/executes the commands received through the input/output interface 106 during gameplay of the video game. For instance, the processor 102 implements the received commands in the random event generator 112, the quest module 114, and the command module 116 of the synergy manager 110. According to an example, the synergy manager 110 is a module, whereby a module includes machine readable instructions to perform certain functions, of multiple modules that are executed to play the video game. For example, video game modules 111a-n are shown to represent other modules performing other functions for a video game. Together, the synergy manager 110 and the modules 111a-n comprise the software for the video game.

The random event generator 112, the quest module 114, and the command module 116 of the synergy manager 110 are operable to facilitate the discovery and execution of a synergy by the player in a video game as described herein.

According to an example, the random event generator 112 randomly generates a synergy notification in response to a player event. According to an example of the present disclosure, the player is randomly and unpredictably awarded with an opportunity to unlock a synergy while performing a player event based on a random synergy algorithm implemented by the random event generator 112. That is, the synergy notification indicates that the player has discovered a synergy with unknown powers. According to another example, the random event generator 112 randomly determines whether a casted spell is categorized as a critical hit using a random critical hit algorithm and further randomly determines whether the critical hit is categorized as an apocalyptical hit using a random apocalyptical algorithm.

According to an example, the quest module 114 generates a synergy quest to determine whether a player has completed the synergy quest to unlock a synergy. For instance, the quest module 114 continuously monitors the actions of the player to determine whether the player has successfully completed the series of actions delegated by the synergy quest and unlocks the synergy and reveals the unique power of the synergy to the player when the player has completed the synergy quest.

According to an example, the command module 116 receives and monitors inputs including, but not limited to, the casting of a spell, a critical hit, a forced critical hit, and an apocalyptical hit by the player. Additionally, after the synergy has been unlocked, the command module activates a synergy time window after registering a first synergy action by the player. The synergy time window, for example, provides the player with an opportunity to achieve a synergy by executing a follow-up synergy action within the synergy time window. The synergy time window is assigned any predetermined amount of time, such as approximately 5 to 6 seconds. Upon registering a successful follow-up synergy action within the synergy time window, the command module 116 executes the synergy.

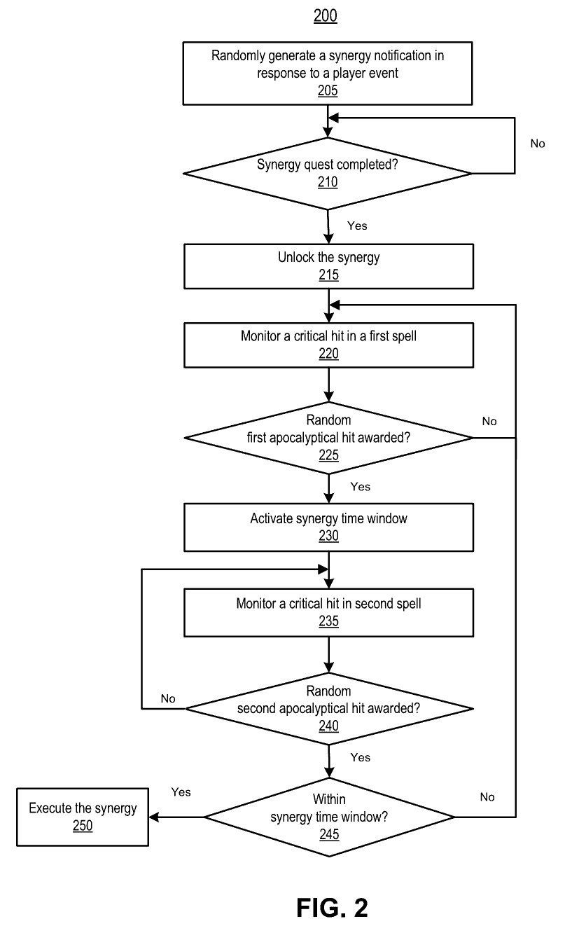

The functions of the random event generator 112, the quest module 114, and the command module 116 of the synergy manager 110 are discussed in greater detail with respect to method 200 in FIG. 2. It should be apparent to those of ordinary skill in the art that the method 200 represents a generalized illustration and that other operations may be added or existing operations may be removed, modified or rearranged without departing from the scopes of method 200.

With reference to FIG. 2, there is shown a flow diagram of the method 200 to discover and execute a synergy in a video game, according to an example of the present disclosure. The method 200 is implemented by, for instance, by the processor 102 of machine 100 as depicted in FIG. 1. In some embodiments, the method 200 is performed by a specialized computer, rather than a generic computer. In such, the specialized computer often includes graphics processors and other hardware that facilitate performing the method 200 and implementing the method 200 as a video game that operates in real-time to perform the operations of the method 200. Furthermore, the method 200 is necessarily rooted in a computerized gaming environment as it is operable to receive gaming inputs from a user input device, which controls the information that is display on a hardware display for playing the game.

In FIG. 2, the random event generator 112, for instance, randomly generates a synergy notification in response to a player event, as shown in block 205. The player event includes, but is not limited to, the crafting of a spell, the casting of a spell, the creating of a weapon, the wielding of a weapon, the uncovering of an in-game item, the communicating with a non-player character, or the use of a player ability. These player events typically occur during the ordinary course of gameplay without unexpected results.

According to an example of the present disclosure, however, the player is awarded with an opportunity to unlock a synergy while performing one of these ordinary player events based on a random synergy algorithm. That is, a synergy notification is randomly and unpredictably generated while the player is performing an ordinary player event. The synergy notification may be visual alert (i.e., pop-up window, banner, badge, caption, etc.), an audio alert, or a tactile alert (i.e., vibrating controller). The synergy notification, for example, is in the form of an in-game item such as a gem, jewel, scroll, ring, and the like. The synergy notification indicates that the player has discovered a synergy.

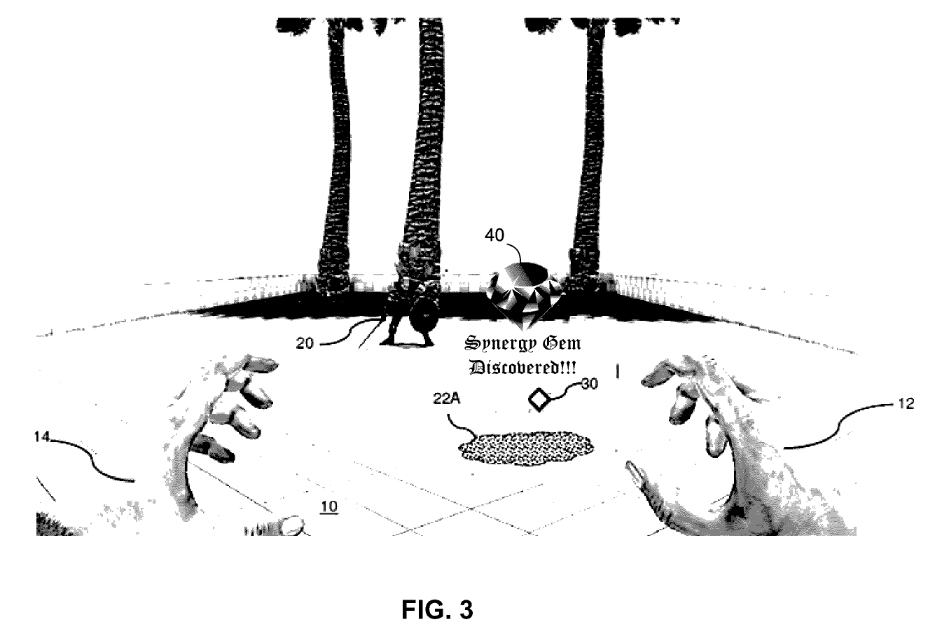

Referring to FIG. 3, a perspective view is shown of a synergy notification during gameplay, according to an example of the present disclosure. In FIG. 3, two hands 12, 14 are shown to represent the hands of the player in the field 10 of the video game. The two hands 12, 14 throw objects or cast spells in the game, although any other depiction such as guns, crossbows, arrows, cannons, howitzers, turrets, and the like, are anticipated. The player aims at an intended target, then invoke a button or trigger on the controller 109 to attempt to inflict harm on the intended target by, for example, shooting a weapon at the target, throwing something at the target, casting a spell on the target, and the like. The intended target is, for instance, an enemy 20. In FIG. 3, an icon-reticule 30 indicates the player's focus and is, in general, where the weapon (e.g., spell, bullet, grenade, etc.) is targeted. By firing upon an intended target, the player has defeated an intended target as represented by a pile of rubble 22A. According to the example in FIG. 3, the defeat of this enemy may be a player event that randomly triggers a synergy notification, such as a visual depiction of a synergy gem 40.

The information provided by the synergy notification, however, is vague regarding the discovered synergy. That is, the synergy notification merely indicates that an unknown synergy has been discovered without indicating the identity of its powers. In some synergy notifications, a synergy quest is included that the player must complete in order to unlock and reveal the unique powers of the synergy. For example, a player is randomly awarded with a synergy gem while crafting a spell. When the player stocks the synergy gem in their equipment set, the synergy quest is then revealed to the player.

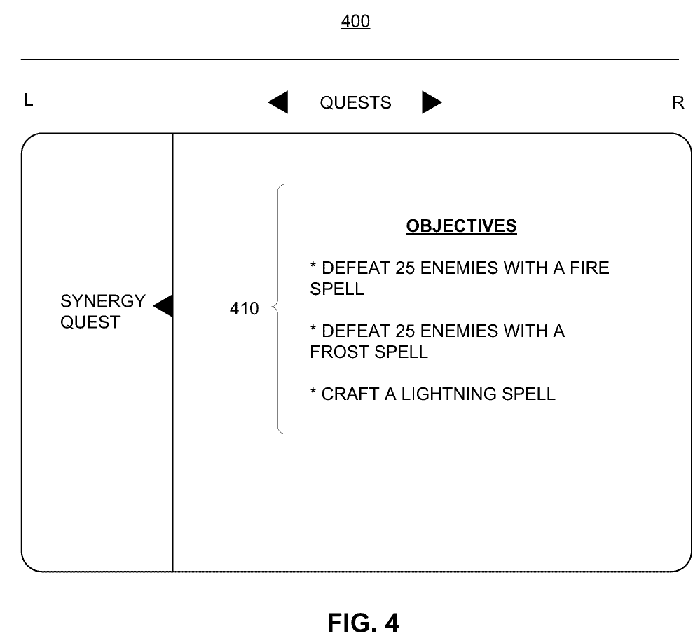

Referring back to FIG. 2, in block 210, the quest module 114, for instance, determines whether the player has completed the synergy quest. According to an example, the synergy quest includes, but is not limited to, a series of actions including defeating an enemy, rescuing a non-player character, locating in-game items, and solving puzzles. As shown in the synergy quest menu 400 of FIG. 4, the synergy quest, for instance, requires the player to complete a list of objectives 410 including defeating twenty-five enemies with a fire spell, defeating another twenty-five enemies with a frost spell, and crafting a lightning spell in order to complete the synergy quest. The quest module 114 continuously monitors the actions of the player to determine whether the player has successfully completed the series of actions delegated by the synergy quest, as shown in block 210 of FIG. 2.

In response to determining that the player has completed the synergy quest, the quest module 114, for instance, unlocks the synergy and reveal the unique power of the synergy to the player, as shown in block 215. At this point, the synergy has been unlocked and is ready to be utilized by the player. For example, the synergy is executed in response to detecting two consecutive synergy actions performed by the player within a predetermined time window as described in blocks 220-250 below. These synergy actions are, for instance, apocalyptical hits in different spells as discussed below. However, is some embodiments, these synergy actions include other extraordinary actions such as a critical hit, an enemy death, or some other event that is not common occurrence, according to other examples.

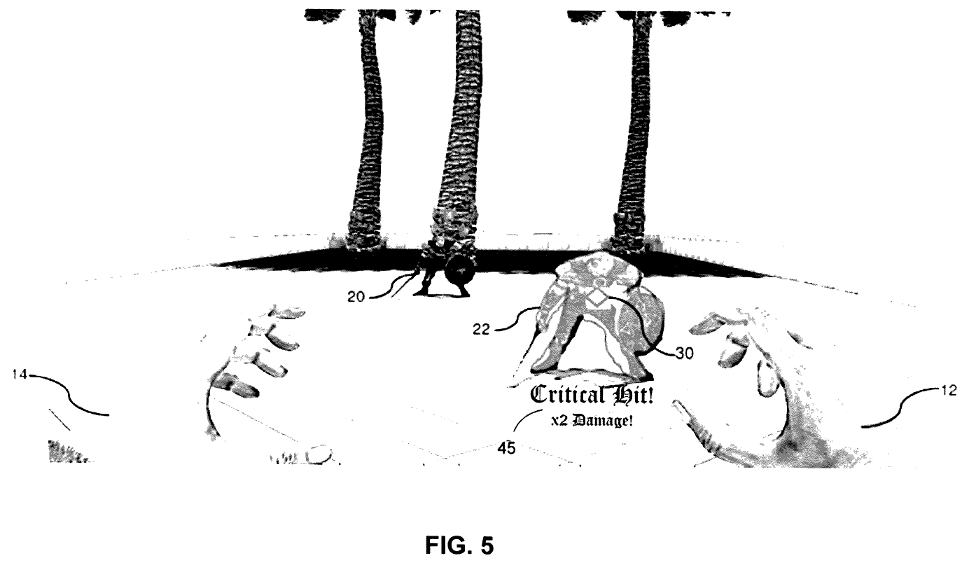

In block 220, the command module 116, for instance, monitors an input of a critical hit in a first spell by the player. An RPG grants the player with many different spells to craft and cast. According to an example, when a player casts a first spell, the random event generator 112 randomly determines whether the casted first spell is categorized as a critical hit. In an example, categorizing as a critical hit may be performed as described in U.S. patent application Ser. No. 14/230,014, entitled “System, Method, and Apparatus for Critical Hits” which is incorporated by reference in its entirety. When a casted first spell is categorized as a critical hit, the casted first spell is optionally awarded an additional power or effect (e.g., double damage, freezing, etc.). As shown in the perspective view of FIG. 5, a spell that was cast upon enemy 22 has been awarded a critical hit. Accordingly, a visual alert 45 informs the player that the casted spell has been randomly categorized as a critical hit with double damage.

According to an example, the player is able to force a critical hit on the first spell instead of relying on the random chance afforded by the random event generator 112. That is, if the player holds the first spell in a charged state by depressing a button or a trigger of the controller 109 for a longer period of time, the player is able to attain a forced critical hit when casting the first spell after the period of time expires. Forcing a critical hit, however, requires skill by the player because the player is exposed to enemy attack while charging the first spell. For example, if a critical hit is awarded on only 20% of casted spells by a critical hits algorithm of the random event generator 112, the player ensures that there is a 100% chance that the casted first spell is awarded a critical hit by charging the first spell for a longer period of time. In other words, the player is trading time for the guaranteed effect of a critical hit.

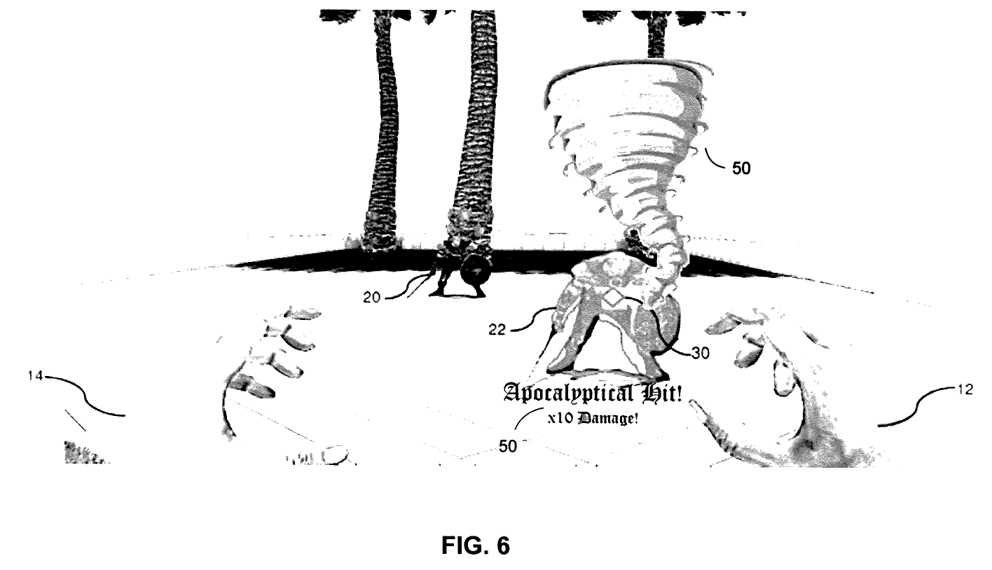

In block 225, the command module 116, for instance, determines whether a random first apocalyptical hit is awarded to the critical hit. According to an example, when a casted first spell is awarded a critical hit, the random event generator 112 further randomly decides whether the critical hit is categorized as a first apocalyptical hit using a random apocalyptical algorithm. A critical hit that is categorized as an apocalyptical hit results in an apocalyptical event with greater powers and effects then a critical hit. For instance, the apocalyptical hit results in the winds changing, the skies darkening, the ground erupting, the virtual world spinning off its axis, and the like. According to an example, the first apocalyptical hit is a first synergy action. As shown in the perspective view of FIG. 6, a spell that was cast upon enemy 22 has been awarded an apocalyptical hit in the form of a tornado 55. Accordingly, a visual alert 50 informs the player that the casted spell has been randomly categorized as an apocalyptical hit with ten times the damage.

According to an example, the player increases the chances of casting an apocalyptical hit by forcing a critical hit as discussed above. For instance, if the base rate for awarding a critical hit on a casted spell is 20% and a base rate for awarding an apocalyptical hit on top of the critical hit is 15%, the chances of casting an apocalyptical hit are quite low. However, by forcing a critical hit on a casted spell, which typically results in a critical hit 100% of the time, the random apocalyptical algorithm applies a portion of the base rate for awarding a critical hit (e.g., 20%) to increase base rate for awarding an apocalyptical hit (e.g., 20%+15%=35% chance of the critical hit being awarded an apocalyptical hit). Therefore, in this example, by forcing a critical hit on a first spell, there is a 35% chance that an apocalyptical hit is awarded on top of the forced critical hit.

According to another example, the player increases the chances of casting an apocalyptical hit by crafting their own first spell. The player, for instance, determines what a critical effect rate for the first spell while crafting the first spell. That is, the player is able to increase the base rate for awarding a critical hit by locating and hunting for the right materials and components to craft a spell with a high critical effect rate. For example, if the base rate for awarding a critical hit is 20%, the player crafts the first spell so that the critical effect rate of the first spell is increased to 50%. In this example, a portion of the base rate for awarding a critical hit (e.g., 20%) is applied to the base rate for awarding apocalyptical hit on top of the critical hit (20%+15%=35%). Therefore, by crafting a spell and determining its critical effect rate, the player increases the chances that an apocalyptical hit is awarded on top of a critical hit awarded to the crafted spell.

Referring to block 225, if the control module 16 determines that the random first apocalyptical hit has not been awarded to a critical hit in the first spell, then the command module 116 continues to monitor additional critical hits in the first spell to determine whether the first apocalyptical hit has been awarded to any of the additional critical hits in the first spell.

In response determining that the random first apocalyptical hit has been awarded to a critical hit in the first spell, the command module 116 activates a synergy time window, as shown in block 230. The synergy time window, for example, provides the player with an opportunity to achieve a synergy by executing a follow-up synergy action within the synergy time window. The follow-up synergy action may be, for example, an apocalyptical hit in a second spell. The synergy time window is assigned any predetermined amount of time, such as approximately 5 to 6 seconds. According to an example, the time window is displayed as a visual alert or notification to the player. Alternatively, the time window is an audio or tactile alert to the player.

In block 235, the command module 116, for instance, monitors input of a critical hit in a second spell. Similar to the above discussion in block 220, when a player casts a second spell, the random event generator 112 randomly decides whether the casted second spell is categorized as a critical hit. Additionally, the player is able to force a critical hit on the second spell instead of relying on the random chance afforded by the random event generator 112. That is, if the player holds the second spell in a charged state by depressing a button or a trigger of the controller 109 for a longer period of time, the player is able to attain a forced critical hit when casting the second spell after the period of time expires. Forcing a critical hit, however, requires skill by the player because the player is exposed to enemy attack while charging the second spell. The player must be fast enough to quickly switch to a different spell and try to repeatedly force critical hits in an attempt to get a random second apocalyptical hit.

In block 240, the command module 116, for instance, determines whether the random second apocalyptical hit is awarded to the critical hit in the second spell. According to an example, when a casted second spell is awarded a critical hit, the random event generator 112 further randomly decides whether the critical hit in the second spell is categorized as a second apocalyptical hit using a random apocalyptical algorithm. As discussed above in block 225, the player increases the chances of casting a second apocalyptical hit by forcing a critical hit in the second spell or crafting their own second spell.

If the command module 116 determines that the random second apocalyptical hit has not been awarded to a critical hit in the second spell, then the command module 116 continues to monitor additional critical hits in the second spell to determine whether the second apocalyptical hit has been awarded to any of the critical hits in the second spell.

In response determining that the random second apocalyptical hit has been awarded to a critical hit in the second spell, the command module 116 determines whether the second apocalyptical hit was awarded within the synergy time window, as shown in block 245. As discussed above, the synergy time window is assigned any predetermined amount of time. If the second apocalyptical hit was not awarded within the synergy time window, then the player has not successfully executed the synergy. Accordingly, the player must restart the process of executing a synergy by performing a critical hit in a first spell as shown in block 220.

However, if the second apocalyptical hit was awarded within the synergy time window, then the player has successfully executed the synergy as shown in block 250. In other words, the command module 116, executes the synergy in response to detecting two consecutive synergy actions (e.g., apocalyptical hits) in different spells within a predetermined time window (i.e., a synergy time window). A synergy, for example, results in awarding the player with a high level of power and prowess that far exceeds that of typical spells (e.g., critical hits, apocalyptical hits), weapons, and potions. A synergy includes, but is not limited to, awarding the player with an innate strength ability, magic ability, healing ability, or combat ability.

Accordingly, disclosed herein are examples of a method to facilitate the discovery and execution of a synergy in a video game. In this regard, the disclosed method may promote an element of discovery to keep the player engaged in the video game while simultaneously challenging the player's skill in executing the discovered synergy. According to the disclosed examples, once a player randomly discovers a synergy with unknown powers, the player embarks upon an adventure of discovery set forth in a synergy quest to unlock the synergy with unknown powers. When the player completes the discovery, they are challenged to execute the unlocked synergy with a combination of complex player actions to unleash the synergy.

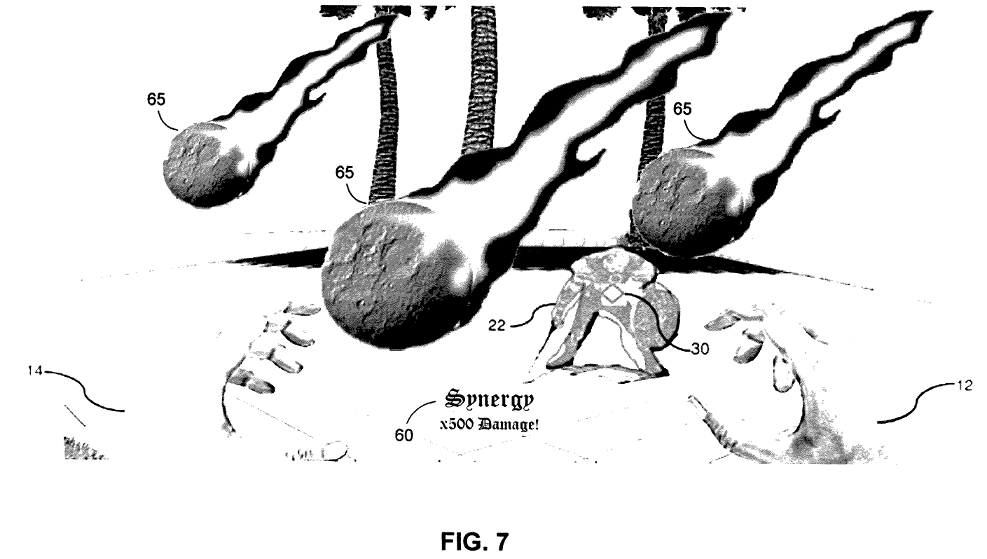

As shown in the perspective view of FIG. 7, a synergy in the form of a meteor shower 65, for example, has been awarded to the player. Accordingly, a visual alert 60 informs the player that the successfully executed synergy has been unleashed on the enemies 20, 22 to inflict five-hundred times the damage. Therefore, the disclosed examples promote a rewarding and fulfilling experience for the player whereby the player feels that they have earned the synergy through their discovery and execution thereof.

What has been described and illustrated herein are examples of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A computerized method to discover and execute a synergy in a video game, comprising:
randomly generating, by a processor, a synergy notification in response to a player event, wherein the synergy notification indicates a discovery of a synergy and includes a synergy quest to be completed by a player;
unlocking the synergy in response to the player completing the synergy quest; and
executing the synergy in response to detecting two consecutive synergy actions within a predetermined time window.

2. The method of claim 1, wherein the synergy notification indicates the discovery of a synergy with unknown power, and wherein the unlocking of the synergy reveals the unknown power of the unlocked synergy.

3. The method of claim 1, wherein the synergy includes at least one of a strength ability, a magic ability, a healing ability, and a combat ability.

4. The method of claim 1, wherein the two consecutive synergy actions include a first apocalyptical hit performed in a first spell followed by a second apocalyptical hit in a second spell.

5. The method of claim 4, wherein the first apocalyptical hit is randomly generated during a critical hit in the first spell and the second apocalyptical hit is randomly generated during a critical hit in the second spell.

6. The method of claim 5, wherein the probability of generating the first and second apocalyptical hits is increased responsive to at least one of:
depressing a trigger button on an input device by the player for a predetermined time period to force a critical hit; and
crafting the first spell and the second spell by the player to increase a critical hit effect rate.

7. The method of claim 1, wherein the player event includes at least one of crafting a spell, casting a spell, creating a weapon, wielding a weapon, uncovering of an in-game item, and using a player ability.

8. The method of claim 1, wherein the player completes the synergy quest by successfully completing a series of actions including at least one of defeating an enemy, rescuing a non-player character, locating in-game items, and solving puzzles.

9. A system comprising:
a processor;
a random event generator, the random event generator randomly generated a synergy notification in response to a player event, wherein the synergy notification indicates a discovery of a synergy with unknown power and includes a synergy quest to be completed by a player;
the processor executes a synergy quest module to unlock the synergy and reveal the identity of its unknown power in response to the player completing the synergy quest; and
a command module, executed by the processor, the command module executes the synergy in response to detecting two consecutive synergy actions within a predetermined time window.

10. The system of claim 9, wherein the command module is to monitor whether the two consecutive synergy actions include a first apocalyptical hit performed in a first spell followed by a second apocalyptical hit in a second spell.

11. The system of claim 10, wherein the random event generator is to determine whether the first apocalyptical hit is randomly generated during a critical hit in the first spell and the second apocalyptical hit is randomly generated during a critical hit in the second spell.

12. The system of claim 10, wherein the random event increases the probability of generating the first and second apocalyptical hits responsive to at least one of:
depressing a trigger button on an input device by the player for a predetermined time period to force a critical hit; and
crafting the first spell and the second spell by the player to increase a critical hit effect rate.

13. A non-transitory computer readable medium including machine readable instructions executed by a processor, the computer readable instructions:
randomly generate a synergy notification in response to a player event, wherein the synergy notification indicates a discovery of a synergy and includes a synergy quest to be completed by a player;
unlock the synergy in response to the player completing the synergy quest; and
execute the synergy in response to detecting two consecutive synergy actions within a predetermined time window.

14. The non-transitory computer readable medium of claim 13, wherein the machine readable instructions are executed by the processor to:
indicate the discovery of a synergy with unknown power in the synergy notification, and
unlock of the synergy to reveal the unknown power of the synergy in response to the player completing the synergy quest.

15. The non-transitory computer readable medium of claim 13, wherein the machine readable instructions are executed by the processor to monitor whether the two consecutive synergy actions include a first apocalyptical hit performed in a first spell followed by a second apocalyptical hit in a second spell.

16. The non-transitory computer readable medium of claim 15, wherein the machine readable instructions are executed by the processor to determine whether the first apocalyptical hit is randomly generated during a critical hit in the first spell and the second apocalyptical hit is randomly generated during a critical hit in the second spell.

17. The non-transitory computer readable medium of claim 15, wherein the machine readable instructions are executed by the processor to increase the probability of generating the first and second apocalyptical hits responsive to at least one of:
depressing a trigger button on an input device by the player for a predetermined time period to force a critical hit; and
crafting the first spell and the second spell to increase a critical hit effect rate.
